(19) United States
(12) Patent Application Publication
(10) Pub. No.: US 2025/0250952 A1
(43) Pub. Date: Aug. 7, 2025

(54) Rocket Engine

(71) Applicant: Astron Systems Ltd, Macclesfield, Cheshire (GB)

(72) Inventors: Rafal Sokolowski, Macclesfield (GB); Eddie Brown, Macclesfield (GB); Kieran Jones-Tett, Macclesfield (GB)

(21) Appl. No.: 19/119,570

(22) PCT Filed: Oct. 11, 2023
(86) PCT No.: PCT/GB2023/052635

§ 371 Date: Apr. 9, 2025

(30) Foreign Application Priority Data
Oct. 13, 2022 (GB) 2215124.5

(51) Int. Cl. F02K 9/48; F01D 15/10; F01D 25/12; F01D 25/22; F02K 9/46; F02K 9/56; F04D 13/06

(52) U.S. Cl. CPC F02K 9/48; F01D 15/10; F01D 25/12; F01D 25/22; F02K 9/46; F02K 9/56; F04D 13/06

(57) ABSTRACT

There is disclosed a rocket engine arranged to deliver one or more propellants to a combustion chamber of the rocket engine for generating motive thrust. The rocket engine comprises an electrical transmission system, a turbine generator unit arranged to receive a propellant flow through the turbine generator unit and to generate electrical power and to pass the generated electrical power to the electrical transmission system, and a motor pump unit arranged to receive electrical power from the electrical transmission system and to use the received electrical power to pump a propellant flow though the motor pump unit.

The present disclosure relates to a rocket engine, to particular components of or for use in such a rocket engine, and to methods of operating such a rocket engine and components. For example, the rocket engine may be a bi-propellant or multi-propellant rocket engine using an engine cycle such as an expander cycle, in which one or more turbines are driven by flows of cryogenic liquid propellants heated using heat from a combustion chamber and/or nozzle, with power from the one or more turbines then being used to drive one or more propellant pumps.

### INTRODUCTION

Many rocket engines, such as liquid bi-propellant rocket engines, use a separate pump to provide a flow of each propellant to a combustion chamber at pressures that exceed the pressure in the combustion chamber itself. Expulsion of the combustion products from the combustion chamber via a nozzle then provides the required motive thrust of the rocket engine during operation. Such pumps may be driven using an expander cycle in which flow of a cold or cryogenic propellant from such a pump is used to cool walls of the combustion chamber and/or nozzle, leading to heating of the propellant which is then used to drive a turbine placed in at least part of the subsequent propellant flow. The turbine is then used to drive one or more of the pumps via a shared or common rotating shaft.

Various different engine cycles may be used, for example a conventional closed expander cycle in which heating of a first of two propellants (typically the fuel propellant) is used to drive a turbine which is coupled to the pump for each propellant, with the turbine exhaust then providing some or all of the first propellant flow to the combustion chamber, and an open expander cycle in which the propellant flow used to drive the turbine is vented to atmosphere instead of being delivered to the combustion chamber. In dual expander cycles, a separate pump-turbine pair may be used for each of two propellants, both of which undergo heating while cooling walls of the combustion chamber and/or nozzle. In some engine cycles a turbine is also or instead driven by combustion products of the propellants.

It would be desirable to address limitations of the related prior art.

### SUMMARY OF THE INVENTION

The invention relates to the use of an electrical transmission system as a replacement for a connecting shaft between a propellant pump and a turbine in a rocket engine. Typically, the turbine may be driven by a propellant through use of an expander cycle, but in some embodiments the turbine may be driven in other ways for example using exhaust gases from a combustion chamber, or using mixture of propellant and combustion products from a pre-burner. The use of an electrical transmission system in this way also enables use of an electrical power store such as a battery to supplement the power available to drive the propellant pump during some time intervals of flight or operation, with the option of excess power from the turbine being stored in the electrical power store at other time intervals of flight or operation. Conversely, use of an electrical transmission system to receive electrical power from a turbine may permit a smaller electrical power store to be used.

A rocket engine implementing these aspects of the invention may then comprise at least one turbine generator unit and at least one motor pump unit, with power transfer from one to the other being electrical instead of mechanical. Each of the turbine generator unit and the motor pump unit may then be fully enclosed so that there are no rotating shafts protruding externally from either, and no rotating shaft connecting the two units, and therefore no requirement for rotary or dynamic shaft seals.

Electrical rotors of the turbine generator unit and motor pump unit may then be immersed or submerged in the working propellant fluid of each unit, which can be used for cooling of the generator or motor, and the shaft within each unit may be supported, at least partially, using hydrostatic bearings integrated within each unit, and for which pressure is supplied using the working propellant fluid of the unit.

Mechanical wear of particular components such as shaft bearings and rotating shaft seals may become prohibitive in smaller scale rocket engines, such as those required for small payload ground to space launch vehicles, because for such smaller scale rocket engines the turbine and pump units are typically quite small therefore requiring much higher rotation speeds to achieve similar high pressures to those of a larger rocket engine. Essentially, due to lower flow rates required in smaller rocket engines, the pump must rotate at higher speeds to achieve the same pressure rise as in larger rocket engines. Various aspects of the invention address this issue by seeking to eliminate rotating shaft seals and providing improved shaft bearings as discussed below.

The described electrical arrangements and operation may also avoid the need for a gas generator or similar additional engine functionality for engine start up, which may be particularly useful for smaller scale rocket engines.

In particular the invention provides a rocket engine, the rocket engine comprising: an electrical transmission system; a turbine generator unit arranged to receive a propellant flow through the turbine generator unit, and to generate electrical power and to pass the generated electrical power to the electrical transmission system; and a motor pump unit arranged to receive electrical power from the electrical transmission system and to use the received electrical power to pump a propellant flow though the motor pump unit. Typically the rocket engine is arranged to deliver the one or more propellants to a combustion chamber of the rocket engine for generating motive thrust through expulsion through a nozzle. The electrical transmission system could be of low complexity, for example comprising electrical conductors to carry the electrical power from the turbine generator unit to the motor pump unit without modification, or could be more complex for example comprising a DC bus, suitable rectifiers and inverters, and suitable control functionality as discussed below.

In particular, the turbine generator may be arranged to generate electrical power from one or more of: the propellant flow through the turbine generator unit; and a flow through the turbine generator unit of combustion products of the one or more propellants. The propellant flowing through the motor pump unit may be the same or a different propellant to that flowing through the turbine generator unit. In practice, the rocket engine may for example comprise two such motor pump units, one for pumping each of two propellants, both motor pump units being powered using electrical power generated either by a single turbine generator unit receiving a flow of one of the propellants, or two turbine generator units, each receiving a flow of a different one of the propellants.

Note that in some embodiments there may be no flow of propellant through the turbine generator unit, for example if only combustion products are used to drive the turbine generator unit and no propellant is used for the bearings and/or cooling of components or parts of the turbine generator unit as discussed below.

The use of separate turbine generator and motor pump units between which power is electrically coupled eliminates the need for seals for different propellants such as fuel and oxidiser on the same rotating shaft, and indeed the need for rotary or dynamic shaft seals, thereby simplifying the mechanical complexity of the system and improving lifetime, reliability, and reusability of the rocket engine.

The use of an electrical instead of a mechanical transmission between the turbine and pump units also permits independent speed control of each unit without the need for gearing, and unlike geared control permits independent speed control between units. This enables the pump and turbine components to be designed for and operated at optimum speeds for each, which is not possible where a shaft is used to provide mechanical power coupling between the two. This independent speed control also permits more precise control over the oxidiser: fuel or other propellant ratio of the rocket engine while being throttled, helping to improve overall engine performance. More precise control of pump speeds also permits control of propellant usage to minimise residual propellant at the end of operation, for example if one propellant is exhausted before the other.

In more detail, the turbine generator unit may comprise a turbine generator shaft, and the motor pump unit may comprise a motor pump shaft. In more detail, the turbine generator unit may comprise a turbine having a rotor arranged to be driven by the propellant flow through the turbine generator and/or by the flow of propellant combustion products through the turbine generator unit, and an electrical generator having a rotor mounted within a stator, the turbine and generator rotors being mounted on the turbine generator shaft shared between them. The motor pump unit may comprise an electrical motor having a rotor mounted within a stator, and a pump having an impeller arranged to pump the propellant flow through the motor pump unit, the rotor and the impeller being mounted on the motor pump shaft shared between them.

The electrical generator may be an induction generator, for example with the generator rotor being a solid, and typically non-laminated, induction rotor. The electrical motor may similarly be an induction motor, for example with the electrical motor rotor being a solid, and typically non-laminated, induction rotor. Such generators and motors help achieve good levels of stability and reliability at high rotational speeds.

The turbine generator shaft may be supported, partially or completely, on hydrostatic bearings for which the bearing pressure is provided using at least a portion of the propellant flow through the turbine generator unit, and/or the motor pump shaft may be supported, partially or completely, on hydrostatic bearings for which the bearing pressure is provided using a portion of the propellant flow through the motor pump unit.

The turbine generator shaft may also or instead be supported on rolling element bearings for which at least a portion of the propellant flow through the turbine generator unit is used as a lubricant, and/or the motor pump shaft may be supported on rolling element bearings for which a portion of the propellant flow through the motor pump unit is used as a lubricant.

At least a portion of the propellant flow through the turbine generator unit may be directed through the electrical generator unit, for example between the stator and the rotor, so as to provide cooling. Similarly, a portion of the propellant flow through the motor pump unit may be directed through the electrical motor for example between the stator and the rotor of the electrical motor so as to provide cooling.

In more detail, a first flow of propellant may be used both to provide hydrostatic bearing pressure and/or rolling element bearing lubrication at one end of the electrical generator or electric motor, then provide cooling of the generator or motor while flowing to the other end of the generator or motor. Typically a separate second flow of propellant will then be used to provide hydrostatic bearing pressure and/or rolling element bearing lubrication at the other end of the electrical generator, with that separate flow of propellant requiring balancing with respect to the first flow for example using a flow restrictor in the separate second flow.

As already mentioned above, the electrical transmission system may further comprise an electrical power store, such as a battery, arranged to provide additional electrical power for use by the motor pump unit to pump the propellant flow through the motor pump unit, and optionally to receive and store excess electrical power from the turbine generator unit. Such an arrangement enables the boosting of power to the motor pump unit(s) beyond that which can be sustained by the turbine generator unit(s) by extraction from the engine cycle alone. This can increase the maximum power able to be delivered to the motor pump units at times of need, and therefore the maximum thrust or performance can exceed, for a limited time period, that possible using a given more conventional mechanical coupling between turbines and pumps.

This boost provided by the electrical power store can for example be used in an early portion of a rocket launch to increase the rocket's thrust: weight ratio and sea level specific impulse, or indeed to reduce the size or complexity of the rocket engine without reducing the resulting thrust: weight ratio.

The electrical transmission system may for example comprise a DC power bus, a rectifier to transmit electrical power from the turbine generator unit to the DC power bus, and an inverter to transmit electrical power from the DC power bus to the motor pump unit. Physical decoupling of the turbine generator unit and motor pump unit in this way also leads to a degree of power transmission smoothing between the two for example due to capacitance effects.

Typically, the turbine generator unit may be arranged to deliver at least 100 KW of electrical power, and the motor pump unit may be arranged to deliver at least 50 KW to the propellant flow through the motor pump unit, but smaller power ratings are also possible.

The turbine generator unit may be arranged to generate six-phase electrical power to pass to the electrical transmission system, and/or the motor pump unit is arranged to receive six phase electrical power from the electrical transmission system for use in pumping the propellant flow though the motor pump unit. Use of six phase power transmission in this way can decrease winding resistance and the electrical current required per phase, enabling the electrical power components to be more compact. However, either or both of the turbine generator unit and motor pump unit could instead use a different number of phases, for example a three-phase power arrangement.

As noted above, the electrical transmission system may be arranged to control a rotational speed of the motor pump unit independently of a rotational speed of the turbine generator unit. This leads to various advantages discussed above for example to permit wider design constraints and/or optimise the rotational speed of each, and permit more flexible and accurate control of propellant pumping rates and ratios.

The described rocket engine and particular components may be used to implement a variety of different engine cycles including expander, tap-off and combustion cycles. However, typically the rocket engine may be arranged such that some or all of the propellant flow pumped by the motor pump unit is subsequently received as the propellant flow through the turbine generator unit. A second motor pump unit arranged to pump another propellant may then also be driven using electrical power from a single turbine generator unit, all also using electrical power from a second turbine generator unit receiving a flow of the other propellant.

Typically, if an expander cycle is implemented, a heat exchanger may be arranged to receive and heat the propellant flow pumped by the motor pump unit, and to deliver some or all of the heated propellant flow on to the turbine generator unit for flow through the turbine generator unit, wherein the turbine generator unit is arranged to generate electrical power from the heated propellant flow.

The invention also provides a turbine generator unit as described herein, and also provides a motor pump unit as described herein, where these units are typically suitable for use in the described rocket engines. The invention therefore provides a turbine generator unit for use in a rocket engine, comprising: a rotor arranged to be driven by a propellant flow through the turbine generator and/or by a flow of propellant combustion products through the turbine generator unit; and an electrical generator having a rotor mounted within a stator, the turbine and generator rotors being mounted on a turbine generator shaft. Typically, the turbine generator shaft may be arranged so as not to extend through a casing of the turbine generator unit.

The turbine generator shaft may be supported on hydrostatic bearings for which bearing pressure is supplied using at least a portion of the propellant flow through the turbine generator unit, and/or may be supported on rolling element bearings lubricated using at least a portion of the propellant flow through the turbine generator unit; and/or at least a portion of the propellant flow through the turbine generator unit may be directed between the stator and the rotor of the electrical generator.

The invention also therefore provides a motor pump unit for use in a rocket engine, comprising: an electrical motor having a rotor mounted within a stator; and a pump having an impeller arranged to pump the propellant flow through the motor pump unit, the rotor and the impeller being mounted on a shared motor pump shaft. Typically, the motor pump shaft may be arranged so as not to extend through a casing of the motor pump unit. Such a motor pump may be used in combination with a described turbine generator pump, or may be powered using only a suitable electrical power store and associated electrical transmission system while still benefiting from advantages described herein such as the use of hydrostatic and/or rolling element bearings using the pumped propellant, and cooling of the electrical motor using the pumped propellant.

The motor pump shaft may be supported on hydrostatic bearings for which bearing pressure is supplied using a portion of the propellant flow through the motor pump unit, and/or may be supported on rolling element bearings lubricated using a portion of the propellant flow through the motor pump unit, and/or a portion of the propellant flow through the motor pump unit may be directed between the stator and the rotor of the electrical motor.

The invention also provides methods of fabricating or constructing the rocket engine described herein, and particular described components of the rocket engine that are described herein, methods of operating such a rocket engine, and methods of operating such components. For example, the invention provides a method of operating a rocket engine using one or more propellants, for example one or more liquid propellants, the method comprising: using a turbine generator unit to generate electrical power from one or more of a propellant flow through the turbine generator unit and a flow through the turbine generator unit of combustion products of the one or more propellants; and using a motor pump unit to pump a propellant flow through the motor pump unit using the generated electrical power.

Such a method may further comprise delivering the propellant flow pumped by the motor pump unit on to a heat exchanger for cooling a combustion chamber and/or nozzle of the rocket engine, then delivering at least a portion of the propellant flow from the heat exchanger to the turbine generator unit to provide the propellant flow through the turbine generator unit.

The method may comprise using an electrical power store to store excess electrical power generated by the turbine generator units and/or to deliver stored electrical power to the motor pump unit. The turbine generator unit and the motor pump unit may be operated at different rotational speeds at the same time, and the speeds of rotation of each may be controlled and varied according to need for example to maximise aspects of performance such as thrust and propellant use.

The method may further comprise one or more of: using a said propellant at each of one or more hydrostatic bearings of the turbine generator and/or the motor pump unit to provide working pressure in the hydrostatic bearings; using a said propellant as a lubricant at each of one or more rolling element bearings of the turbine generator and/or the motor pump unit; and using a said propellant as a coolant for an electrical generator of the turbine generator unit and/or an electrical motor of the motor pump unit.

### BRIEF SUMMARY OF THE DRAWINGS

Embodiments of the invention will now be described, by way of example only, with reference to the drawings of which:

FIG. 1 shows a rocket engine implementing a closed expander engine cycle using electrical power transmission between a turbine generator unit and two motor pump units;

FIG. 2 illustrates in cross section a motor pump unit suitable for use in the rocket engine of FIG. 1;

FIG. 3 illustrates in cross section a turbine generator unit suitable for use in the rocket engine of FIG. 1;

FIG. 4 shows the rocket engine of FIG. 1 modified to use an open expander engine cycle;

FIG. 5 shows the rocket engine of FIG. 1 modified to use a dual expander engine cycle with a separate turbine generator unit and a separate motor pump unit for each of two propellants;

FIG. 6 shows the rocket engine of FIG. 1 modified to use a tap-off cycle in which the turbine generator unit is driven using propellant combustion products tapped from the combustion chamber; and

FIG. 7 shows the rocket engine of FIG. 1 modified to use a staged combustion engine cycle in which the turbine generator unit is driven using a partially combusted propellant mix.

### DETAILED DESCRIPTION OF THE EMBODIMENTS

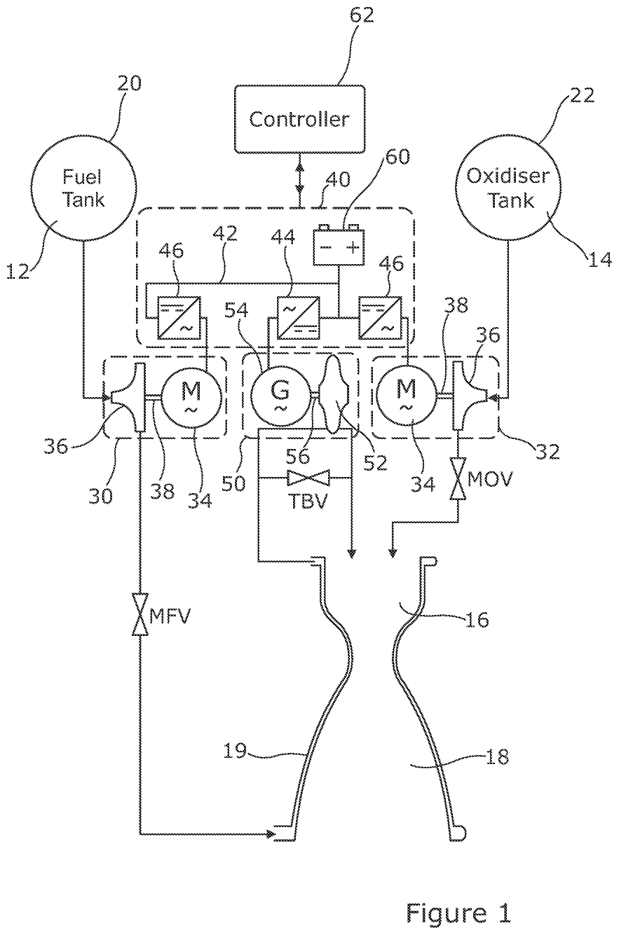

Referring now to FIG. 1 there is shown schematically a rocket engine which implements an expander cycle to deliver at least first and second propellants 12, 14 to a combustion chamber 16 for combustion, the products of which are expelled through a nozzle 18 to provide the required motive thrust of the rocket engine when in operation. In this particular arrangement the first propellant 12 is a fuel such as liquid hydrogen, methane or propane stored in cold, typically cryogenic liquid form in first propellant tank 20, and the second propellant 14 is an oxidiser such as liquid oxygen stored in cold, typically cryogenic liquid form in a second propellant tank 22. Note that other embodiments of the invention may implement a mono-propellant rocket engine using a single liquid propellant, a rocket engine using a single liquid propellant and a solid propellant, or various other propellant combinations and numbers. Typically the propellant(s) flowing as described within the rocket engine will be liquid propellants, although some phase change of such liquid propellants may occur before combustion in some engine designs.

In order to deliver each propellant to the combustion chamber 16 at a sufficiently high pressure to overcome the working pressure in the combustion chamber, each propellant 12, 14 is pumped from the respective tank 20, 22 using a respective motor pump unit. In particular in FIG. 1, a first motor pump unit 30 pumps a flow of the first propellant from the first propellant tank 20 towards the combustion chamber 16, and a second motor pump unit 32 pumps a flow of the second propellant 14 from the second propellant tank 22 towards the combustion chamber 16. Notably, each motor pump unit 30, 32 carries out its respective pumping operation using electrical power received from an electrical transmission system 40, rather than using mechanical power received from another part of the rocket engine as would be conventional in the prior art.

To this end, each motor pump unit comprises an electrical motor 34 arranged to drive a pump 36 using electrical power received from the electrical transmission system 40. The electrical motor drives the pump via a rotating motor pump shaft 38 shared between the motor 34 and the pump 36. The pump is then arranged to drive the propellant flow through the motor pump unit. Typically, as discussed further below, the pump will comprise an impeller for this purpose, and the motor will comprise a rotor, and the impeller and the rotor will be mounted or fixed to the shared motor pump shaft 38.

Electrical power for driving the motor pump units 30, 32 is generated and provided to the electrical transmission system 40 at least in part by one or more turbine generator units 50. These turbine generator units may be driven either by a propellant flow, or a flow of combustion products of the propellants, or a combination of the two. In FIG. 1 a single turbine generator unit 50 is provided and is driven by a flow of the first propellant 12, but in other expander cycle arrangements a turbine generator unit could be driven at least in part by a flow of combustion products from the combustion chamber 16, a flow of combustion products from a pre-burner, or a flow of the second propellant. In other arrangements separate turbine generator units each could be driven by flows of each of the first and second propellants. Even if no propellant flow is used to drive the turbine, in the described embodiments a propellant flow through the turbine generator unit is still typically provided and used for other purposes, for example one or more of lubricating rolling element bearings, providing pressure to hydrostatic bearings, and cooling the electrical generator as discussed below.

The, or each, turbine generator unit 50 comprises a turbine 52 and an electrical generator 54. In FIG. 1 the turbine is arranged to be driven by the propellant flow through the turbine generator unit 50, and is arranged in turn to drive the electrical generator 54 via a rotating turbine generator shaft 58 shared between the turbine 52 and the electrical generator 54. The electrical generator 54 is then arranged to provide the electrical power recovered from the propellant flow to the electrical transmission system 40. Typically, as discussed further below, the electrical generator will comprise a rotor within a stator for generating the electrical power, and the turbine will comprise a rotor for extracting mechanical power from the propellant flow, with the turbine rotor and generator rotors being mounted or fixed to the shared turbine generator shaft 58.

In FIG. 1, the first pump unit 30 drives a flow of the first propellant 12, optionally via a master fuel valve MFV, to a heat exchanger 19 which is configured such that the first propellant absorbs heat from the combustion of the propellants, thereby acting as a regenerative cooling loop which both enables operation of the expander cycle and provides cooling of the combustion chamber and/or nozzle. The heat exchanger 19 may typically comprise one or more conduits, within or around some or all areas of the walls of the combustion chamber 16 and/or nozzle 18, through which the propellant to be heated flows. During operation of the rocket engine, these walls are at a high temperature, leading to heating and expansion of the propellant within the conduits so that the onward flow of propellant to the turbine generator unit 50 can be used to provide electrical power to the electrical transmission system 40 for driving the motor pump units 30, 32. The heat exchanger 19 also fulfils the function of cooling the walls of the combustion chamber and/or nozzle.

In the closed expander cycle of FIG. 1 most or all of the first propellant 12 is used to drive the turbine generator unit 50, with some bypass of the propellant flow around the turbine generator unit 50 being permitted by an optional turbine bypass valve TBV. All of the first propellant is then injected into the combustion chamber 16. All of the second propellant 14 which is pumped by the second motor pump unit 32 is also delivered to the combustion chamber, optionally through a master oxidiser valve MOV. In other engine cycle implementations such as those discussed below, the propellant flows and controls of those flows may be used and implemented in various other ways.

Because the one or more motor pump units 30, 32 pump the propellant flows using electrical power from the electrical transmission system rather than requiring mechanical power transmission from the one or more turbine generator units, no mechanical power coupling such as a shared shaft is required between respective propellant pumps and turbines. This simplifies the mechanical engineering challenges considerably, in particular by avoiding the need for one or more shafts, rotating at high speed, which extend between spaces in which different propellants are present. This would require reliable and difficult to engineer propellant seals to prevent leakage and potential dangerous mixing of propellant. Instead, the motor pump unit(s) and turbine generator unit(s) can be provided as sealed units with no requirement for dynamic or rotary shaft seals.

More generally, such rotating shafts or other mechanical power couplings between propellant pumps and propellant turbines are difficult and expensive to engineer so as to be reliable over multiple uses of the rocket engine. The provision of an electrical transmission system instead of a mechanical transmission system between one or more propellant turbines and one or more propellant pumps in a rocket engine cycle therefore significantly improves reliability of the rocket engine and makes reuse of the rocket engine without drastic overhaul between each use easier to achieve.

Using the described electrical transmission arrangement, the propellant pumps and turbines can be provided as separate sealed units without risk of propellant leakage between the two which can arise if a rotational drive shaft or other mechanical coupling between the two is used.

The use of an electrical transmission instead of a mechanical transmission arrangement also leads to other advantages. It becomes more straightforward to operate the propellant pumps and turbines at different rotational speeds. This can be achieved in prior art expander cycles through use of a mechanical gear box between the two, but this is usually difficult to engineer reliably at the very high rotational speeds required, increases engine weight, and likely permits only a single ratio of speeds between a turbine and a pump. Using the described electrical transmission arrangement, the speeds of a turbine and one or more pumps can be controlled independently through electronic control.

Moreover, in operation of the rocket engine 10, storage and subsequent use of excess electrical power, and/or the provision of excess electrical power before or at engine start up can be implemented within the electrical transmission system by including an electrical power store 60 such as a chemical battery or supercapacitor bank as part of the electrical transmission system 40. This can be used to smooth out discrepancies in power supply and demand between the one or more turbine generator units and the one or more motor pump units over various time scales, for example on short time scales of a few seconds due to fluctuations in performance, or over longer timescales between different phases of a rocket launch or other operation.

Typically, the one or more electrical generators 54 and more generally the turbine generator units 50 will generate and provide AC electrical power to the electrical transmission system 40, and the one or more electrical motors 34 and more generally motor pump units 30 will use and receive AC electrical power from the electrical transmission system 40. Although the transmission system could be of low complexity and simply transmit such AC power using suitable conductors, the electrical transmission system 40 may advantageously comprise a DC power bus 42 which is used to couple electrical power received from the one or more turbine generator units to the one or more motor pump units as described above. The electrical transmission system may therefore also comprise a rectifier 44 associated with each turbine generator unit 50 which is arranged to convert AC power from the turbine generator unit for delivery to the DC power bus, and an inverter 46 associated with each motor pump unit 30 which is arranged to convert DC power from the DC power bus to AC power for delivery to the respective motor pump unit. Of course, a single rectifier could be used for two or more turbine generator units, and a single inverter could be used for one of more motor pump units.

The electrical power store 60 mentioned above may then also conveniently be coupled to the DC power bus as shown in FIG. 1, for receiving and storing excess electrical power generated by the one or more turbine generator units and/or for storing extra electrical power before start of operation of the rocket engine. The electrical power store may typically be provided by a chemical battery comprising a plurality of chemical cells, for example lithium ion, by a bank of super capacitors, by other types of electrical power storage elements, or combinations of these.

Each of the one or more electrical motors 34 may comprise an induction motor or more particularly a solid rotor induction motor, and each of the one or more electrical generators 54 may comprise an induction generator or more particularly a solid rotor induction generator. Such induction electrical machines and solid rotor induction electrical machines are able to provide high levels of reliability and stability at the high rotational speeds typical of the described turbine generator and motor pump units. Conveniently, the one or more electrical motors and/or one or more electrical generators may be implemented to receive or generate six phase AC power, to thereby decrease winding resistance and the electrical current required per phase of the required or generated AC power.

The rocket engine 10 of FIG. 1 also comprises a controller 62, typically coupled to the electrical transmission system 40 as well as to other parts of the rocket engine 10 including valves (such as the MFV, TBV and MOV shown in FIG. 1) and various sensors. The controller 62 will typically be implemented using software on a suitable computer system, and among other functions, may be arranged to control the rotational speeds, and relative rotational speeds of the one or more electrical motors and electrical generators, to cause excess electrical power received at the DC bus 42 from the electrical generators to be stored in the electrical power store 60, and to deliver electrical power from the electrical power store 60 to the DC bus for use by the electrical motors 34 when required. In particular, the controller 62 may be arranged to control rotational speeds of the one or more motor pump units independently of rotational speeds of the one or more turbine generator units, and if required to control rotational speeds of a plurality of motor pump units independently of each other, and/or to control rotational speeds of a plurality of turbine generator units independently of each other, to thereby adjust these various speeds for optimal performance of the rocket engine including during different phases of flight.

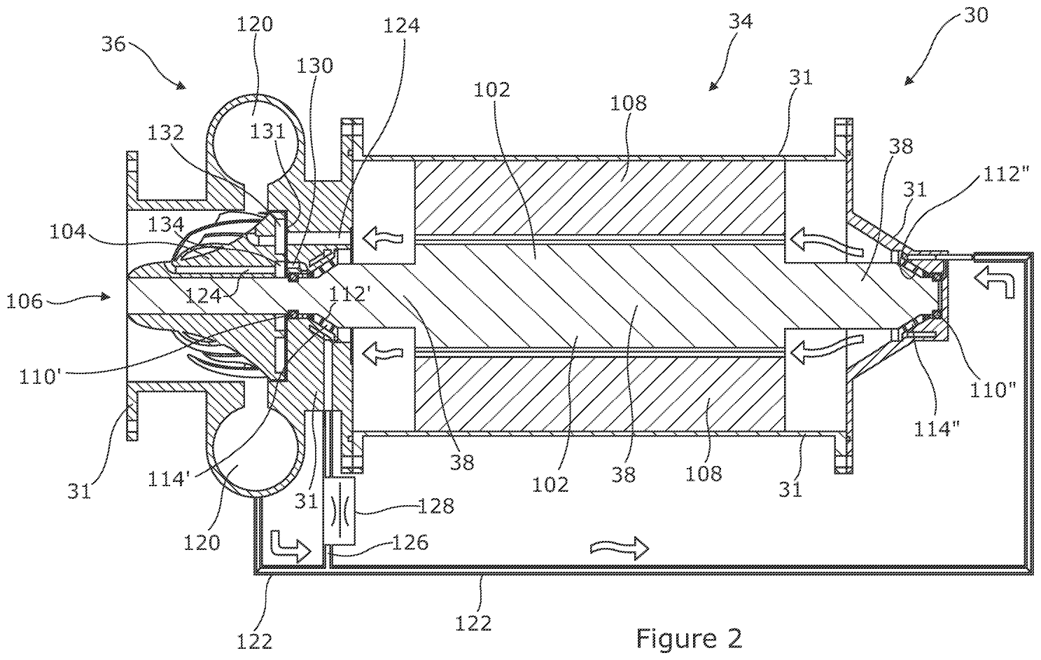

FIG. 2 shows in more detail how a motor pump unit 30 of FIG. 1 may be implemented. As discussed above in respect of FIG. 1 the motor pump unit 30 comprises an electrical motor 34 (for example a solid rotor induction motor), a pump 36, and a motor pump shaft 38 coupling rotation of a rotor 102 of the motor to rotation of an impeller 104 of the pump. The propellant enters the pump 36 at an entrance port 106 to encounter the impeller 104 from the left of FIG. 2, and is pumped by the impeller into an output volute 120 for onward flow towards the combustion chamber.

The motor 34, shaft 38, pump 36 and other components of the motor pump unit are disposed within a motor pump unit casing 31 which conveniently can be sealed in the sense that no rotating shaft passes through the casing, which would require a shaft seal to prevent leakage of the propellant flowing within the motor pump unit.

If the motor is a solid rotor induction motor then the rotor 102 may be formed integrally with the motor pump shaft 38. Typically, however, the rotor may be provided using a material such as copper beryllium surrounding a steel core which also forms a part of the motor pump shaft. The rotor of the motor rotates within a stator 108 comprising a plurality of stator windings (not separately shown in the figure). As discussed above, the stator and rotor together may implement a six phase induction motor receiving AC power from the electrical transmission system 40 of FIG. 1 to drive rotation of the pump 36 and impeller 104 and therefore to pump a propellant flow from the entrance port 106 to the output volute 120 and on towards the combustion chamber 16.

The motor pump shaft 38 is supported on bearings. One or both of rolling element bearings 110 and hydrostatic bearings 112 may be used. If both are provided then the rolling element bearings may provide stability at lower rotational speeds as the pump spins up at the start of rocket engine operation, and the hydrostatic bearings may provide improved stability and reliability at higher rotational speeds during established operation as propellant pressure suitable for the hydrostatic bearings becomes available. This use of hydrostatic bearings then decreases wear and risk of failure of the rolling element bearings, improving overall reliability. In the arrangement of FIG. 2 both rolling element bearings and hydrostatic bearings are used, with proximal rolling element bearings 110′ and proximal hydrostatic bearings 112′ supporting the shaft 38 between the rotor 102 and the impeller 104, and distal rolling element bearings 110″ and distal hydrostatic bearings 112″ supporting the shaft beyond the end of the rotor distal from the impeller, although other arrangements of bearings may be used.

The bearing pressure for operation of the hydrostatic bearings 112, and/or lubrication of the rolling element bearings 110, may be provided using the propellant being pumped by the motor pump unit, and in particular by a portion of the propellant pumped and/or flowing through the motor pump unit. Outward flow of this portion of the propellant to the bearings, and return flow to the main propellant flow in the pump is shown in FIG. 2 using the open arrows.

Although other arrangements may be used, in the arrangement of FIG. 2 delivery of propellant flow to the bearings is achieved by bleeding a small portion of the pumped propellant flow from the volute 120 along a conduit 122 for delivery to a bearing manifold 114″ which injects the bled propellant into the distal hydrostatic bearing 112″. On leaving the distal hydrostatic bearing 112″, this propellant then flows axially back towards the impeller 104 to the end of the motor proximal to the pump, and from there via a first return channel 124 back into the main propellant flow in the vicinity of the impeller 104, and upstream of the volute 120.

Some of the propellant directed along the conduit 122 is diverted along a conduit side branch 126, which may comprise a flow restrictor 128, for delivery to a bearing manifold 114′ which injects propellant into the proximal hydrostatic bearing 112′. On leaving the proximal hydrostatic bearing 112′, this propellant is delivered back into the main propellant flow upstream of the volute via a second return channel 130.

Propellant for lubricating the proximal and distal rolling element bearings 110′, 110″ may be provided by essentially the same route, with flow to the distal rolling element bearings 110″ via the conduit 122, and flow to the proximal rolling element bearings 110′ via the conduit side branch 126 and flow restrictor 128.

The flow restrictor 128 serves to passively balance the mass flow rates through the proximal and distal hydrostatic bearings, since the propellant paths for the two are likely to be of different lengths, and as discussed below the propellant path via the distal bearings may also pass between the rotor and stator of the motor, increasing the resistance of that flow path.

The first and second return channels 124, 130 of the propellant back to the main propellant flow upstream of the volute may form part of a balance piston arrangement at a rear face 131 of the impeller 114. In particular, either or both of the first and second return channels 124, 130 may direct the propellant into corresponding first and second open annular spaces 132, 134 in the rear face of the impeller 114 to provide a thrust on the impeller towards the entrance port 106 which counters a thrust by the propellant entering the pump axially through the entrance port 106. The respective first and second return channels may then continue as channels from these open annular spaces through a body of the impeller 114 as shown in FIG. 2 to deliver the associated propellant flows into the main propellant flow adjacent to the impeller and upstream of the volute 120.

Note that although separate first and second return channels for the bled propellant are shown in FIG. 2, these could be combined into a single return channel via the body of the impeller, using a single corresponding open annular space in the rear face of the impeller 104 for provision of the balance piston arrangement described above. Alternatively, both first and second return channels, or a single combined return channel, could deliver the bled propellant to the propellant flow upstream of the impeller.

A portion of the propellant flow through the motor pump unit 30 may also be used to provide cooling of the motor, for example by directing this portion of the flow between the stator and the rotor of the motor. In the arrangement of FIG. 2 this is achieved by directing the bled propellant after use at the distal rolling element and/or hydrostatic bearings to flow axially back towards the pump between the stator and rotor. In other embodiments however, this propellant flow could be directed in the opposite direction and/or not form part of the flow used as described above for the distal bearings.

Use of a portion of the propellant flow through the motor pump unit 30 to provide one or more of lubrication of rolling element bearings, pressure to hydrostatic bearings, and cooling of the motor, is made more practical by the omission of any mechanical power coupling between the motor pump unit and a corresponding turbine generator unit. Because of this lack of mechanical power coupling the motor pump unit can be more completely sealed with respect to the propellant except for the main entry and exit points of the pump at the entrance port 106 and volute 120, so that operational risks of propellant leakage or of mixing of different propellant types due to such leakages are obviated or at least significantly reduced.

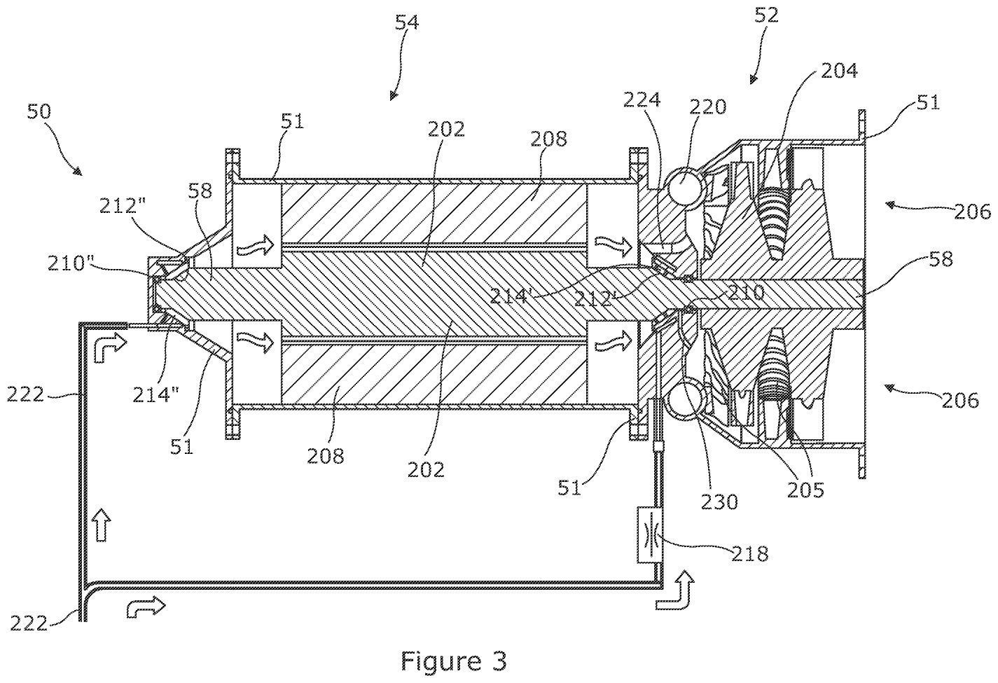

FIG. 3 shows in more detail how a turbine generator unit 50 of FIG. 1 may be implemented. As discussed above in respect of FIG. 1 the turbine generator unit 50 comprises an electrical generator 54 (for example a solid rotor induction generator), a turbine 52, and a turbine generator shaft 58 coupling rotation of a rotor 204 of the turbine 52 (right side of figure) to rotation of a rotor 202 of the electrical generator 54 (left side of the figure). Static stages 205 of the turbine are also shown in the figure. In the engine cycle illustrated in FIG. 1, the heated propellant enters the turbine 52 at an inlet manifold 220 and then through a plurality of injectors (not shown in the figure) to encounter the turbine rotor 204, and drives rotation of the turbine rotor 204 before being discharged into an exit port 206 for flow on towards the combustion chamber, or in some engine cycles to be discharged to atmosphere in whole or in part. In some engine cycles the turbine may be driven at least partly using combustion products from the combustion chamber 19, and/or from a pre-burner as well as, or instead of, using a propellant flow for this purpose.

The turbine 52, electrical generator 54, shaft 58, and other components of the turbine generator unit are disposed within a turbine generator unit casing 51 which conveniently can be sealed in the sense that no rotating shaft passes through the casing which would require a shaft seal to prevent leakage of the propellant flowing within the unit.

If the generator is a solid rotor induction generator then the generator rotor 202 may be formed integrally with the turbine generator shaft 58. Typically, however, the rotor may be provided using a material such as copper beryllium surrounding a steel core which also forms a part of the turbine generator shaft. The rotor of the generator rotates within a stator 208 comprising a plurality of stator windings (not separately shown in the figure). As discussed above, the stator and rotor together may implement a six phase induction generator delivering AC power to the electrical transmission system 40 of FIG. 1 to supply to the one or more pump drive units.

Similar to the motor pump shaft 38, the turbine generator shaft 58 is supported on bearings. One or both of rolling element bearings 210 and hydrostatic bearings 212 may be used. If both are provided then the rolling element bearings may provide stability at lower rotational speeds as the turbine 52 spins up at the start of rocket engine operation, and the hydrostatic bearings may provide improved stability and reliability at higher rotational speeds during established operation as propellant pressure suitable for the hydrostatic bearings becomes available. This use of hydrostatic bearings then decreases wear and risk of failure of the rolling element bearings, improving overall reliability. In the arrangement of FIG. 3 both rolling element bearings and hydrostatic bearings are used, with proximal rolling element bearings 210′ and proximal hydrostatic bearings 212′ supporting the shaft 58 between the generator rotor 102 and the turbine rotor 204, and distal rolling element bearings 210″ and distal hydrostatic bearings 212″ supporting the shaft beyond the end of the generator rotor distal from the turbine rotor, although other arrangements of bearings may be used.

The bearing pressure for operation of the hydrostatic bearings 212, and lubrication of the rolling element bearings 210, may be provided using a flow of propellant through the turbine generator unit, and optionally a portion of the flow of propellant driving the turbine 52, and in particular by a portion of the propellant driving and/or flowing through the turbine generator unit 50. Flow of propellant to the bearings, and onward flow typically to the main propellant or other driving flow in the turbine 52 is shown in FIG. 3 using the open arrows.

Although other arrangements may be used, in the arrangement of FIG. 3 delivery of propellant flow to the bearings is achieved by bleeding a small portion of the propellant flow from upstream of the inlet manifold 220, for example from a tap of the propellant flow, along a conduit 222 for delivery to a bearing manifold 214″ which injects the bled propellant into the distal hydrostatic bearing 212″. On leaving the distal hydrostatic bearing 212″, this propellant then flows axially towards the turbine rotor 204 to the end of the electrical generator proximal to the turbine, and from there via a first return channel 224 into the main propellant or other driving flow in the vicinity of the injection manifold 220, and upstream of the turbine rotor 204.

Some of the propellant directed along the conduit 222 is diverted along a conduit side branch 226, which may comprise a fixed flow restrictor 228, for delivery to a bearing manifold 214′ which injects propellant into the proximal hydrostatic bearing 212′. On leaving the proximal hydrostatic bearing 212′, this propellant is delivered back into the main propellant or other driving flow upstream of the turbine rotor 204 via a second return channel 230.

Propellant for lubricating the proximal and distal rolling element bearings 210′, 210″ may be provided by essentially the same route, with flow to the distal rolling element bearings 210″ via the conduit 222, and flow to the proximal rolling element bearings 210′ via the conduit side branch 226 and flow restrictor 228, and discharge of the propellant flow from the rolling element bearings typically via the same return channels as the flows from the hydrostatic bearings.

The flow restrictor 228 serves to passively balance the mass flow rates through the proximal and distal hydrostatic bearings, since the propellant path via the distal bearings is likely to present greater resistance to flow than that via the proximal bearings, including for example because the propellant path via the distal bearings may also pass between the rotor and stator of the electrical generator, increasing the resistance of that flow path.

Note that although separate first and second return channels for the bled propellant are shown in FIG. 3, these could be combined into a single return channel upstream of the turbine rotor 204. Alternatively, both first and second return channels, or a single combined return channel, could deliver the bled propellant to the propellant or other discharged flow downstream of the turbine rotor.

A portion of the propellant flow through the turbine generator unit 50 may also be used to provide cooling of the electrical generator 54, for example by directing this portion of the flow between the stator and the rotor of the motor. In the arrangement of FIG. 3 this is achieved by directing the bled propellant after use at the distal rolling element and/or hydrostatic bearings to flow axially towards the turbine between the stator and rotor. In other embodiments however, this cooling propellant flow could be directed in the opposite direction and/or not form part of the flow used as described above for the distal bearings.

In a manner similar to that of the motor pump unit described above, use of propellant flow through the turbine generator unit 50 to provide one or more of lubrication of rolling element bearings, pressure to hydrostatic bearings, and cooling of the electrical generator, is made practical by the omission of any mechanical power coupling between the turbine generator unit and a corresponding motor pump unit. Because of this lack of mechanical power coupling the turbine generator unit can be more completely sealed with respect to the propellant or other flow driving the turbine except for the main entry and exit points of the turbine at the inlet manifold 220 and exit port 206, so that operational risks of propellant or combustion product leakage or of mixing of different propellant types due to such leakages are obviated or at least significantly reduced.

Although a single source is illustrated by conduit 222 in FIG. 3, the tap or bleed of propellant flow for use by the bearings and/or electrical generator may be made at the same point or at different points in the propellant flow upstream of the injection manifold for each of delivery to each of the distal bearings and proximal bearings, and for cooling the electrical generator. For example, tapping the propellant flow between the upstream pump motor unit and the heat exchanger 19 leads to a cooler flow at higher pressure, tapping between the heat exchanger 19 and the inlet manifold 220 provides a warmer flow at lower pressure, and tapping within the inlet manifold itself may provide a slightly lower pressure flow again.

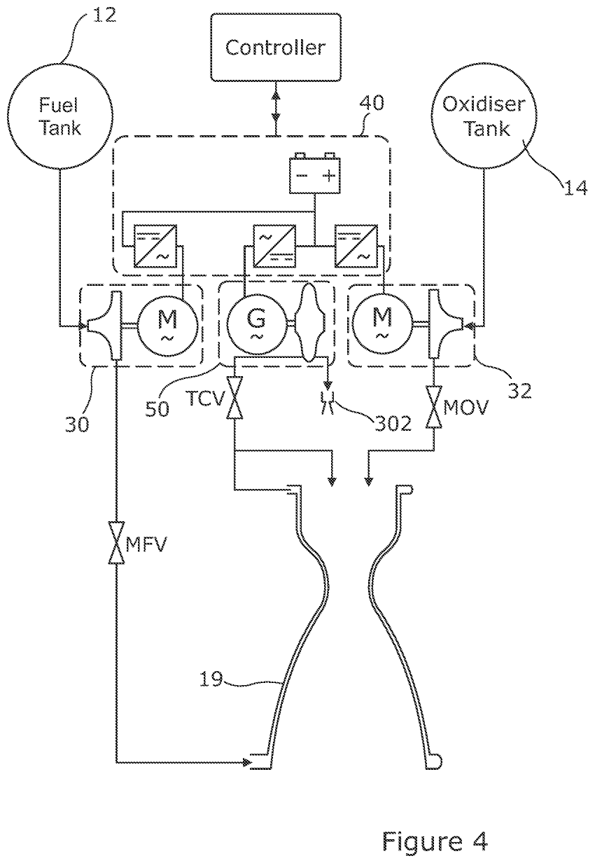

Although FIG. 1 illustrates the described motor pump unit(s) 30, turbine generator unit(s) 50 and electrical transmission system 40 being used in the context of a closed expander cycle in which the turbine is driven by a heated flow of a propellant, these elements may be used in variations of this closed expander cycle, and in a variety of other rocket engine cycles, for example those illustrated in FIGS. 4 to 7. In these figures, for the sake of clarity, where the same reference numerals as in claim 1 apply they have not usually been repeated.

In some variations of the closed expander cycle of FIG. 1, instead of the first (typically fuel) propellant 12, the second (typically oxidiser) propellant 14 may be directed through the heat exchanger 19 and then through the turbine generator unit 50 to generate electrical power to feed to the electrical transmission system 40. In other variations, the turbine bypass valve TBV may be omitted or replaced by a simple flow restrictor. The master fuel valve MFV or master oxidiser valve MOV may be positioned upstream of their respective motor pump units. The heat exchanger 19 providing regenerative cooling may be provided along the entire length of the combustion chamber and nozzle, or along only part of parts of this length.

FIG. 4 is similar to FIG. 1, but illustrates an open expander cycle using most of the same elements as FIG. 1, but in which the propellant discharged from the exit port 206 of the turbine 52 is vented to atmosphere typically without combustion, optionally via a secondary nozzle 302. This enables more power to be extracted from the propellant flow by the turbine 52 compared with the closed expander cycle of FIG. 1, enabling rocket engine designs capable of producing higher motive thrust.

In FIG. 4, no turbine bypass valve TBV is required, but instead an optional turbine control valve TCV may be placed in the full propellant flow between the heat exchanger 19 and the turbine generator unit 50. The flow of propellant to the combustion chamber itself is then separated from the flow of propellant to the turbine generator unit after exit from the heat exchanger 19 and before the turbine control valve. However, the turbine control valve may be omitted altogether or replaced with a fixed flow restrictor.

Similar to FIG. 1, instead of the first (typically fuel) propellant 12, in FIG. 4 the second (typically oxidiser) propellant 14 may be directed through the heat exchanger 19 and then through the turbine generator unit 50 to generate electrical power to feed to the electrical transmission system 40. The master fuel valve MFV and/or master oxidiser valve MOV may be positioned upstream of their respective motor pump units, and the heat exchanger 19 providing regenerative cooling may be provided along the entire length of the combustion chamber and nozzle, or along only part or parts of this length.

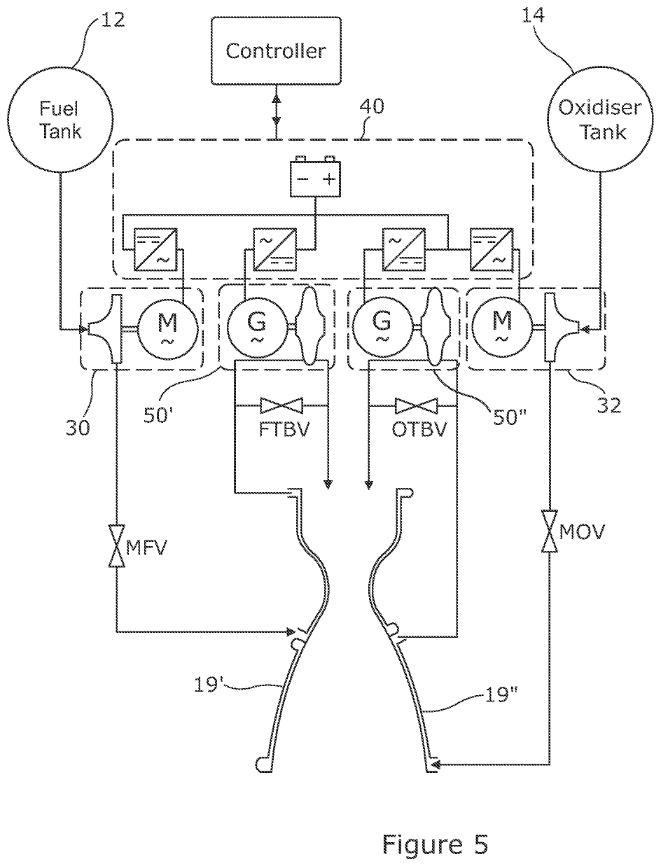

FIG. 5 is similar to FIG. 1, but illustrates a dual expander cycle in which each propellant 12, 14 is passed through a separate heat exchanger 19′, 19″, and from there to a separate turbine generator unit 50′, 50″. The fuel bypass valve of FIG. 1 is then duplicated between the fuel and oxidiser sides as a fuel turbine bypass valve FTBV and an oxidiser turbine bypass valve OTBV. Advantages of this dual expander cycle are reduced turbine inlet temperatures, a reduction in the maximum required system pressure, and reduced electrical power ratings for the electrical generators and electrical motors.

The two separate heat exchangers 19′, 19″ of FIG. 5 may be disposed in separate areas of the combustion chamber and nozzle, or intermingled. As for the other engine cycles discussed above, the master fuel valve MFV and/or master oxidiser valve MOV may be positioned upstream of their respective motor pump units.

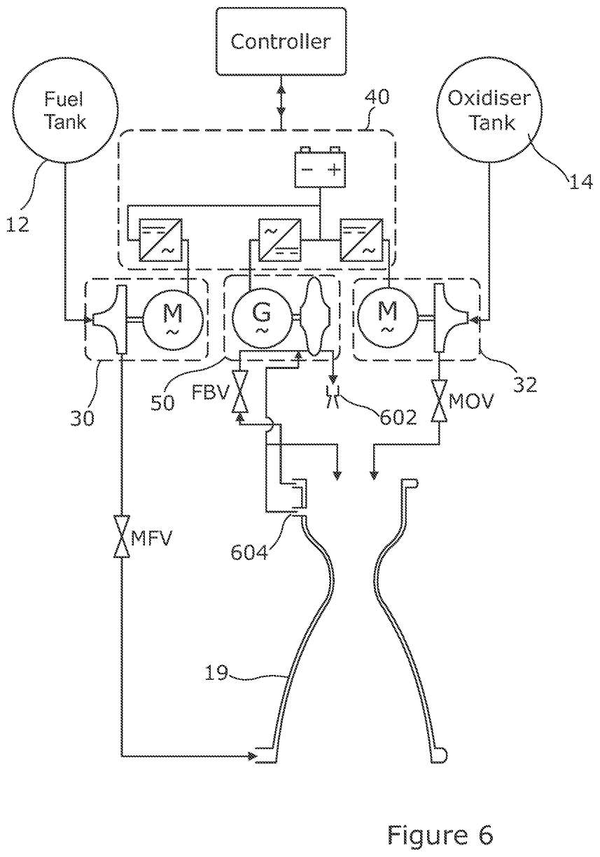

FIG. 6 is similar to FIG. 4, in illustrating an open cycle in which exhaust from the turbine is vented to atmosphere optionally via a secondary nozzle 602. However, in the combustion tap-off cycle of FIG. 6, the turbine is partly or completely driven by a tap 604 of hot exhaust gases from the combustion chamber 16. The propellant heated by the heat exchanger 19 is then primarily injected directly into the combustion chamber, but a small portion of this is fed instead via a fuel bypass valve FBV to provide the propellant flow to the turbine generator unit for providing one or more of pressure for hydrostatic bearings, lubrication of rolling element bearings, and cooling of the electrical generator as already described above. If required, a portion of the propellant from the heat exchanger may be mixed with the hot exhaust gas flow from the combustion chamber, for example in the injection manifold of the turbine, so that this mixture drives the turbine at a lower temperature.

The tap-off engine cycle of FIG. 6 allows the turbine generator unit 50 to generate more electrical power than is possible by driving the turbine solely using flow of the propellant from the heat exchanger 19. This cycle can also use a flow of the other propellant, so in the arrangement of FIG. 6 the oxidiser, instead of the fuel, to provide the propellant flow for the bearings and/or generator cooling of the turbine generator unit 50.

The fuel bypass valve FBV (or oxidiser bypass valve if appropriate) may be omitted or replaced by a more simple flow restrictor, and as for other described cycles, the main fuel and oxidiser bypass valves may be positioned upstream of their respective motor pump units.

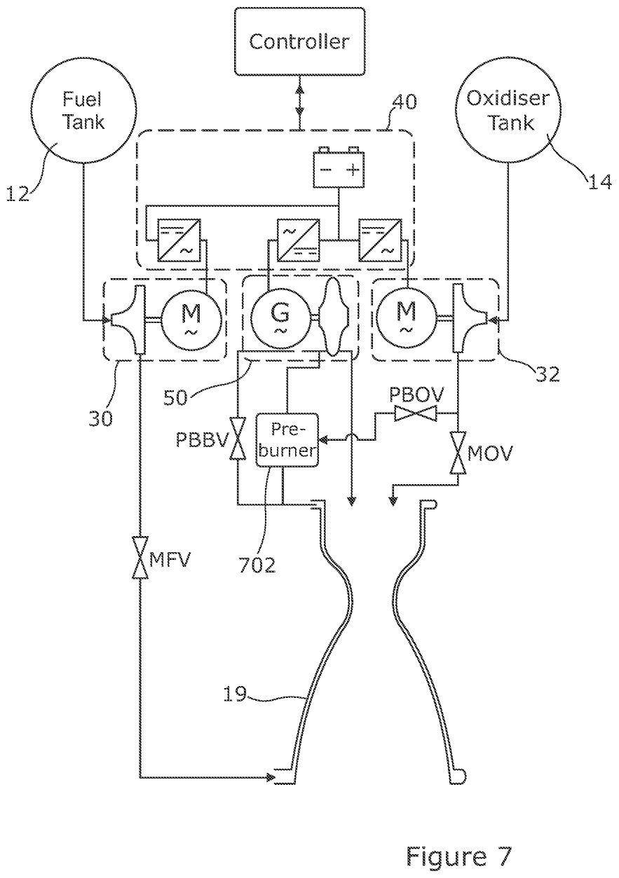

FIG. 7 illustrates a further engine cycle which may use the described turbine generator unit(s), motor pump unit(s) and electrical transmission system. In this cycle the fuel propellant leaving the heat exchanger 19 is partially combusted in a pre-burner 702 through mixing with a portion of the oxidiser flow downstream of the oxidiser motor pump unit, and via a pre-burner oxidiser valve PBOV. The fuel rich, partially combusted fuel flow is then used to drive the turbine of the turbine generator unit. In variations of this, an oxidiser rich, partially combusted flow may instead be used to drive the turbine. This pre-burner scheme increases the enthalpy of the flow at the inlet manifold of the turbine beyond that generally possible using regenerative cooling alone, so that more electrical power can be generated by the turbine generator unit.

In FIG. 7, an optional pre-burner bypass valve PBBV controls a tap of the fuel flow from the heat exchanger 19 to provide a propellant flow to the turbine for use by the bearings and/or cooling of the electrical generator. This tap of the fuel flow takes place before the pre-burner to ensure a cooler flow for these purposes.

In FIG. 7 the turbine exhaust gases are injected into the combustion chamber, but in other arrangements the turbine exhaust may instead be vented to atmosphere, optionally via a secondary nozzle (not shown).

Although particular embodiments have been described, a number of alternatives and variations will be apparent to the skilled person without departing from the invention for example as set out in the claims. For example although engine cycles using two liquid propellants have been described in detail, the invention may be used to implement engine cycles using just one or more than two liquid propellants. The described embodiments may be used in rocket engines designed for a variety of different purposes including, but not limited, to the ground to space launching of satellites.

1. A rocket engine arranged to deliver one or more propellants to a combustion chamber of the rocket engine for generating motive thrust, the rocket engine comprising:
an electrical transmission system;
a turbine generator unit arranged to receive a propellant flow through the turbine generator unit, and to generate electrical power and to pass the generated electrical power to the electrical transmission system; and
a motor pump unit arranged to receive electrical power from the electrical transmission system and to use the received electrical power to pump a propellant flow though the motor pump unit.

2. The rocket engine of claim 1 wherein the turbine generator unit is arranged to generate electrical power from one or more of: the propellant flow through the turbine generator;
and a flow through the turbine generator of combustion products of the one or more propellants.

3. The rocket engine of claim 2 wherein:
the turbine generator unit comprises a turbine having a rotor arranged to be driven by the propellant flow through the turbine generator and/or by the flow of propellant combustion products through the turbine generator unit, and an electrical generator having a rotor mounted within a stator, the turbine and generator rotors being mounted on a shared turbine generator shaft; and
the motor pump unit comprises an electrical motor having a rotor mounted within a stator, and a pump having an impeller arranged to pump the propellant flow through the motor pump unit, the rotor and the impeller being mounted on a shared motor pump shaft.

4. The rocket engine of claim 3 wherein the electrical generator is an induction generator and the generator rotor is a solid induction rotor, and/or wherein the electrical motor is an induction motor and the electrical motor rotor is a solid induction rotor.

5. The rocket engine of claim 3 wherein at least a portion of the propellant flow through the turbine generator unit is directed between the stator and the rotor of the electrical generator to provide cooling of the electrical generator, and/or a portion of the propellant flow through the motor pump unit is directed between the stator and the rotor of the electrical motor to provide cooling of the electrical motor.

6. The rocket engine of claim 1 wherein the turbine generator unit comprises a turbine generator shaft, and the motor pump unit comprises a motor pump shaft.

7. The rocket engine of claim 3 wherein the turbine generator shaft is supported at least partly on hydrostatic bearings for which bearing pressure is supplied using at least a portion of the propellant flow through the turbine generator unit, and/or the motor pump shaft is supported at least partly on hydrostatic bearings for which bearing pressure is supplied using a portion of the propellant flow through the motor pump unit.

8. The rocket engine of claim 3 wherein the turbine generator shaft is supported at least partly on rolling element bearings lubricated using at least a portion of the propellant flow through the turbine generator unit, and/or the motor pump shaft is supported at least partly on rolling element bearings lubricated using a portion of the propellant flow through the motor pump unit.

9. The rocket engine of claim 3 wherein the turbine generator shaft is supported on first bearings at an end of the rotor of the electrical generator distal from the turbine and on second bearings at an end of the rotor of the electrical generator proximal to the turbine, wherein at least a first portion of the propellant flow through the turbine generator unit is directed to the first bearings before subsequently flowing between the stator and the rotor of the electrical generator, and/or at least a second portion of the propellant flow through the turbine generator unit is directed through a flow restrictor to the second bearings.

10. The rocket engine of claim 3, wherein the motor pump shaft is supported on first bearings at an end of the rotor of the electrical motor distal from the pump and on second bearings at an end of the rotor of the electrical motor proximal to the pump, wherein a first portion of the propellant flow through the motor pump unit is directed to the first bearings before subsequently flowing between the stator and the rotor of the electrical motor, and/or a second portion of the propellant flow through the motor pump unit is directed through a flow restrictor to the second bearings.

11. The rocket engine of claim 9 wherein the first and second bearings comprise hydrostatic bearings, and the first and second portions of the propellant flow provide operating pressure to the hydrostatic bearings.

12. The rocket engine of claim 1 wherein the electrical transmission system further comprises an electrical power store, such as a battery, arranged to provide additional electrical power for use by the motor pump unit to pump the propellant flow through the motor pump unit, and optionally to receive and store excess electrical power from the turbine generator unit.

13. The rocket engine of claim 1 wherein the electrical transmission system comprises a DC power bus, a rectifier to transmit electrical power from the turbine generator unit to the DC power bus, and an inverter to transmit electrical power from the DC power bus to the motor pump unit.

14. The rocket engine of claim 1 wherein the turbine generator unit is arranged to deliver at least 100 KW of electrical power, and the motor pump unit is arranged to deliver at least 50 KW to the propellant flow through the motor pump unit.

15. The rocket engine of claim 1 wherein the turbine generator unit is arranged to generate six-phase electrical power to pass to the electrical transmission system, and the motor pump unit is arranged to receive six phase electrical power from the electrical transmission system for use in pumping the propellant flow though the motor pump unit.

16. The rocket engine of claim 1 wherein the electrical transmission system is arranged to control a rotational speed of the motor pump unit independently of a rotational speed of the turbine generator unit.

17. The rocket engine of claim 1 arranged such that some or all of the propellant flow pumped by the motor pump unit is subsequently received as the propellant flow through the turbine generator unit.

18. The rocket engine of claim 1 further comprising a heat exchanger arranged to receive and heat some or all of the propellant flow pumped by the motor pump unit, and to deliver some or all of the heated propellant flow on to the turbine generator unit for flow through the turbine generator unit, wherein the turbine generator unit is arranged to generate electrical power from the propellant flow.

19. The rocket engine of claim 1 comprising two of said motor pump units arranged to pump different ones of said propellants, wherein both motor pump units are arranged to use the electrical power generated by the turbine generator unit.

20. A turbine generator unit for use in a rocket engine, comprising:
a rotor arranged to be driven by a propellant flow through the turbine generator and/or by a flow of propellant combustion products through the turbine generator unit; and
an electrical generator having a rotor mounted within a stator, the turbine and generator rotors being mounted on a turbine generator shaft which does not extend through a casing of the turbine generator unit.

21. The turbine generator unit of claim 20 wherein one or more of:
the turbine generator shaft is supported at least partly on hydrostatic bearings for which bearing pressure is supplied using at least a portion of the propellant flow through the turbine generator unit;
the turbine generator shaft is supported at least partly on rolling element bearings lubricated using at least a portion of the propellant flow through the turbine generator unit; and
at least a portion of the propellant flow through the turbine generator unit is directed between the stator and the rotor of the electrical generator for cooling of the electrical generator.

22. A motor pump unit for use in a rocket engine, comprising:
an electrical motor having a rotor mounted within a stator; and
a pump having an impeller arranged to pump the propellant flow through the motor pump unit, the rotor and the impeller being mounted on a shared motor pump shaft which does not extend through a casing of the motor pump unit, wherein one or more of:
the motor pump shaft is supported at least partly on hydrostatic bearings for which bearing pressure is supplied using a portion of the propellant flow through the motor pump unit;
the motor pump shaft is supported at least partly on rolling element bearings lubricated using a portion of the propellant flow through the motor pump unit; and a portion of the propellant flow through the motor pump unit is directed between the stator and the rotor of the electrical motor.

23. A method of operating a rocket engine using one or more propellants, the method comprising:
using a turbine generator unit to generate electrical power from one or more of a propellant flow through the turbine generator unit and a flow through the turbine generator unit of combustion products of the one or more propellants; and
using a motor pump unit to pump a propellant flow through the motor pump unit using the generated electrical power.

24. The method of claim 23 further comprising: delivering the propellant flow pumped by the motor pump unit on to a heat exchanger for cooling a combustion chamber and/or nozzle of the rocket engine, then delivering at least a portion of the propellant flow from the heat exchanger to the turbine generator unit to provide the propellant flow through the turbine generator unit.

25. The method of claim 23 further comprising using an electrical power store to store excess electrical power generated by the turbine generator units and/or to deliver stored electrical power to the motor pump unit.

26. The method of claim 23 further comprising operating the turbine generator unit and the motor pump unit at different rotational speeds at the same time.

27. The method of claim 23 further comprising one or more of: using a said propellant at each of one or more hydrostatic bearings of the turbine generator and/or the motor pump unit to provide working pressure in the hydrostatic bearings; using a said propellant as a lubricant at each of one or more rolling element bearings of the turbine generator and/or the motor pump unit; and using a said propellant as a coolant for an electrical generator of the turbine generator unit and/or an electrical motor of the motor pump unit.
